(19) United States
(12) Patent Application Publication
(10) Pub. No.: US 2016/0092975 A1
(43) Pub. Date: Mar. 31, 2016

(54) PORTRAIT BASED PRODUCT TO PARTICIPANT MAPPING

(71) Applicant: Poshly Inc., New York, NY (US)

(72) Inventors: Bradley Falk, San Francisco, CA (US); Doreen Bloch, New York, NY (US); Matthew Drescher, San Francisco, CA (US)

(21) Appl. No.: 14/596,434

(22) Filed: Jan. 14, 2015

Related U.S. Application Data
(60) Provisional application No. 62/057,147, filed on Sep. 29, 2014.

(51) Int. Cl. G06Q 30/06

(52) U.S. Cl. CPC G06Q 30/0643

(57) ABSTRACT

Participant data for a participant is acquired. A feature vector is defined. Attributes of the participant are determined from the participant data. A participant feature vector for the participant is generated using the defined feature vector and the determined attributes of the participant. The participant is mapped to a portrait using the participant feature vector. A product is mapped to the portrait. The product is mapped to the participant based on the mapping of the participant to the portrait and the mapping of the product to the portrait.

### CROSS REFERENCE TO RELATED APPLICATIONS

This application claims the benefit under 35 U.S.C. §119(e) of U.S. Provisional Application No. 62/057,147 filed Sep. 29, 2014, which is hereby incorporated by reference.

### BACKGROUND

An area of ongoing research and development is mapping products to participants for, for example, targeted advertising. Due to the perceived value of improving the likelihood of a mapping is an accurate estimate of actual participant interest in a product, even incremental improvements in the quality of the estimate is considered valuable. One of the best estimates that can be obtained involves a participant entering their actual interests. However, it is often difficult to encourage a participant to spend the effort to enter interests. In addition, privacy concerns make certain techniques used to track user activity more difficult. Mobile commerce also introduces some additional limitations, such as a perceived need for cookie-less transactions.

Improvements over the relevant art will become apparent to those of skill in the relevant art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

A system maps a participant to a portrait and a product or service to the portrait. Interaction with the participant in association with the product or service is based upon the mappings. The system can improve participant-to-portrait mapping by capturing input associated with the participant to more effectively map multiple participants to the relevant portraits. Portraits can be implemented as statistical data structures that change over time in response to collected data points.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for mapping a product to a participant based on portraits.

FIG. 2 depicts a diagram of an example of a system for generating a feature vector for a participant.

FIG. 3 depicts a diagram of an example of a feature vector data structure.

FIG. 4 depicts a diagram of an example of a system for mapping a participant to a portrait using a participant feature vector for the participant.

FIG. 5 depicts a diagram of an example of a system for mapping products to a participant based on portraits.

FIG. 6 depicts a diagram of an example of a system for acquiring participant data used in mapping participants to products based on portraits.

FIG. 7 depicts a flowchart of an example of a method for mapping a product to a participant based on portraits.

FIG. 8 depicts a flowchart of an example of a method for mapping a participant to a portrait based on attributes of the participant.

FIG. 9 depicts a flowchart of an example of a method for mapping a product to a portrait.

FIG. 10 depicts a flowchart of an example of a method for determining if participant data is valid.

FIG. 11 depicts a diagram of an example of a system for participant interaction after product-to-portrait mapping.

FIG. 12 depicts a flowchart of an example of a method for participant interaction after product-to-portrait mapping.

### DETAILED DESCRIPTION

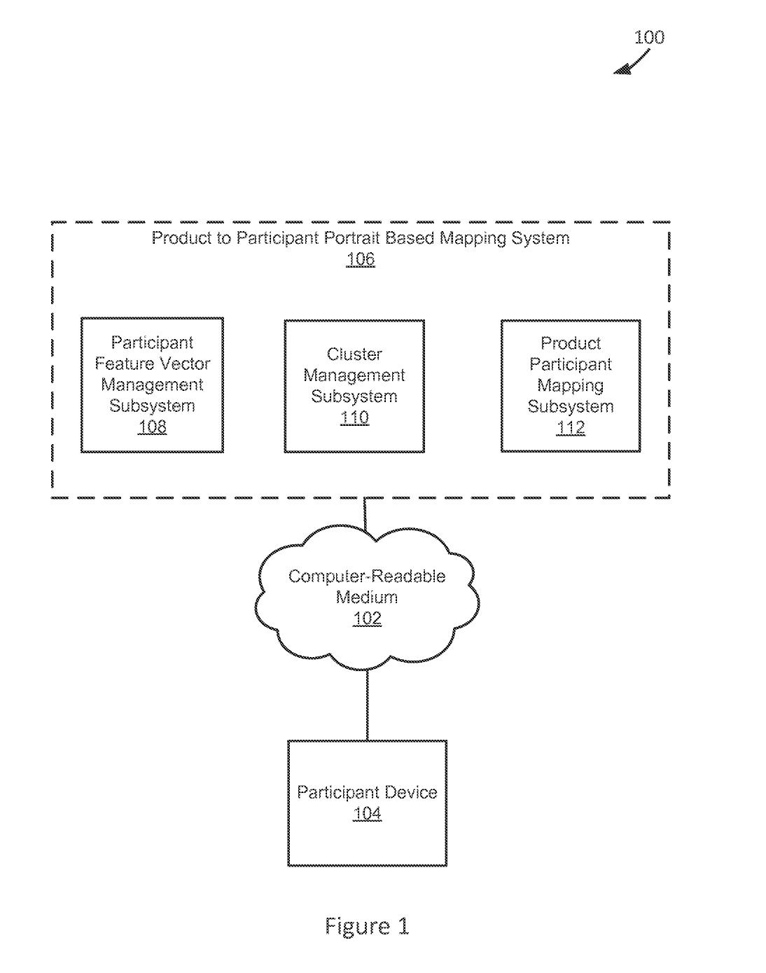

FIG. 1 depicts a diagram 100 of an example of a system for mapping a product to a participant based on portraits. The system of the example of FIG. 1 includes a computer-readable medium 102, a participant device 104, and a product to participant portrait based mapping system 106.

The participant device 104 and the product to participant portrait based mapping system 106 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the participant device 104, the product to participant portrait based mapping system 106, and other applicable systems, or devices described in this paper can be implemented as a computer system, a plurality of computer systems, or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a specific-purpose processor such as a central processing unit (CPU) or a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the FIGs. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

The participant device 104 is intended to represent an applicable device through which a participant can interact with systems described in this paper. The participant device 104 can be, for example, a thin client or an ultra-thin client. In a specific implementation, the participant device 104 is used in the generation of participant data. As used in this paper, participant data includes data used in determining attributes of a participant.

In a specific implementation, participant data indicates whether a participant likes a product and/or features of the participant. In a specific example of operation, participant data is generated as a result of a participant using the participant device 104 to enter a giveaway of a product. Depending upon implementation-specific or other considerations, participant data can be input to the participant device 104 through a web portal. Participant data can be used to determine a feature vector for a participant. Further depending upon implementation-specific or other considerations, participant data can be generated for participants in response to input triggers perceived by a participant or interactions with products by the participant. For example, an input trigger can be a question whether a participant likes a specific product or expresses a desire for the specific product, and participant data can indicate an answer as to whether the participant likes the specific product or expresses a desire for the specific product.

The product to participant portrait based mapping system 106 is intended to represent an engine to map a product to a participant using portraits. As used in this paper, a portrait includes a plurality of clusters and is defined by the attributes of participants in the plurality of clusters. As used in this paper, a cluster includes a participant or a subset of participants grouped together according to one or a plurality of attributes of the participants in the cluster, the attributes of the participant in the cluster thereby defining the cluster. As used in this paper, attributes of a participant can include features, characteristics, and traits defining a participant. For example, attributes of a participant can include an age and sex of the participant. Depending upon implementation-specific or other considerations, attributes of a participant can include products a participant uses. Attributes of a participant can serve as market segmentation variables used to segment participants into groups. Examples of market segmentation variables can include geographic, demographic, psychographic, behavioristic, and/or other data about one or more market segments.

In a specific implementation, the product to participant portrait based mapping system 106 functions to map a participant to a portrait based on attributes of the participant. In mapping a participant to a portrait, the product to participant portrait based mapping system 106 can generate one or a plurality of feature vectors for the participant based on the attributes of the participant. As used in this paper, a feature vector is organizational data structure indicating determined attributes of a participant. The product to participant portrait based mapping system 106 can define a feature vector for a participant and populate attribute fields included as part of the feature vector to indicate attributes of the participant, as determined from participant data received and generated in response to the participant interacting with the participant device 104. In mapping a participant to a portrait, the product to participant portrait based mapping system 106 can map the participant to one or a plurality of clusters included in the portrait, using a participant feature vector of the participant.

In a specific implementation, the product to participant portrait based mapping system 106 maps a product to a participant based on a portrait mapped to the participant and a portrait mapped to the product. In mapping a product to a participant based on mapped portraits, the product to participant portrait based mapping system 106 can map a product to a portrait. Based on a portrait mapped to a product, and a portrait mapped to a participant, the product to participant portrait based mapping system 106 cam map the product to the participant. For example, if a product is mapped to a specific portrait, and a participant is mapped to the specific portrait, then the product to participant portrait based mapping system 106 can map the product to the participant.

In the example system shown in FIG. 1, the product to participant portrait based mapping system 106 includes a participant feature vector management subsystem 108, a cluster management subsystem 110, and a product to participant mapping subsystem 112. In a specific implementation, the participant feature vector management subsystem 108 functions to determine at least one feature vector for a participant. In generating at least one feature vector for a participant, the participant feature vector management subsystem 108 can communicate with the participant device 104 to obtain participant data. In communicating with the participant device 104, the participant feature vector management subsystem 108 can send trigger inputs to the participant device 104 and receive participant data or data used to generate participant data form the participant device 104. In generating a feature vector for a participant, the participant feature vector management subsystem 108 can determine attributes of the participant from participant data for the participant. Depending upon implementation-specific or other considerations, the participant feature vector management subsystem 108 can define a feature vector to include a number of specific attributes of participants. Further depending upon implementation-specific or other considerations, the participant feature vector management subsystem 108 can determine a feature vector for a participant based on a defined feature vector and determined attributes of the participant.

In a specific implementation, the cluster management subsystem 110 functions to map a participant to a participant to a portrait based on a participant feature vector of the participant. In mapping a participant to a portrait, the cluster management subsystem 110 can function to define a cluster. The cluster management subsystem 110 can define a cluster according to an applicable number of attributes of participants. For example, a cluster can be defined based on a single attribute or a plurality of attributes. In mapping a participant to a portrait, the cluster management subsystem 110 can map a participant to a portrait by mapping the participant to a defined cluster. Further, in mapping a participant to a portrait, the cluster management subsystem 110 can map a participant to a portrait based on clusters to which a participant is mapped and portraits that include the clusters. For example if a participant is mapped to a cluster included in a specific portrait, then the cluster management subsystem 110 can map the participant to the specific portrait.

In a specific implementation, the product participant mapping subsystem 112 functions to map a product to a participant based on a portrait to which the product is mapped and a portrait to which the participant is mapped. In mapping a product to a participant based on portraits, the product participant mapping subsystem 112 can map products to specific portraits based on attributes of participants defining clusters included in the portraits, and/or attributes of participants defining the portraits. For example, if the product participant mapping subsystem 112 determines that a product should be advertised to males between 25-30 years old, then the product participant mapping subsystem 112 can map the product to portraits including clusters defined by participants who are males between the ages of 25-30 years old. Depending upon implementation-specific or other considerations, the product participant mapping subsystem 112 can map a product to a portrait based on input from either or both an administrator, developer, or provider of a product. For example, if a developer of a product determines that a product should be targeted to females between the ages of 25-30 years old, then the product participant mapping subsystem 112 can map the product to portraits including clusters defined by females between the ages of 25-30 years old.

In a specific implementation, in mapping products to a participant based on a portrait, the product participant mapping subsystem 112 can map a participant to a product if the product has been mapped to a specific portrait, and the specific portrait has been mapped to the participant. In mapping products to a participant based on a portrait, the product participant mapping subsystem 112 may or may not map products to specific portraits based on how participants mapped to the specific portraits have interacted with the products. Depending upon implementation-specific or other considerations, the product participant mapping subsystem 112 can map a product to a portrait if participants mapped to the portrait have indicated a liking of the product, as included as part of participant data. Further depending upon implementation-specific or other considerations, the product participant mapping subsystem 112 can map a product to a portrait if participants mapped to the portrait have purchased the product in response to advertising of the product, as included as part of participant data.

In an example of operation, the participant feature vector management subsystem 108 collects participant data of a participant based on participant data input to the participant device 104 and/or the ways in which the participant interacts with the participant device 104. In this example of operation, the participant feature vector management subsystem 108 generates a participant feature vector for the participant based on attributes of the participant determined from the participant data. In this example of operation, the cluster management subsystem 110 maps the participant to at least one cluster based using the participant feature vector. In this example of operation, the cluster management subsystem 110 maps the participant to a portrait based on the at least one cluster to which the participant is mapped. In this example of operation, the product participant mapping subsystem 112 maps a product to the portrait. In this example of operation, the product participant mapping subsystem 112 maps the product to the participant based on the portrait.

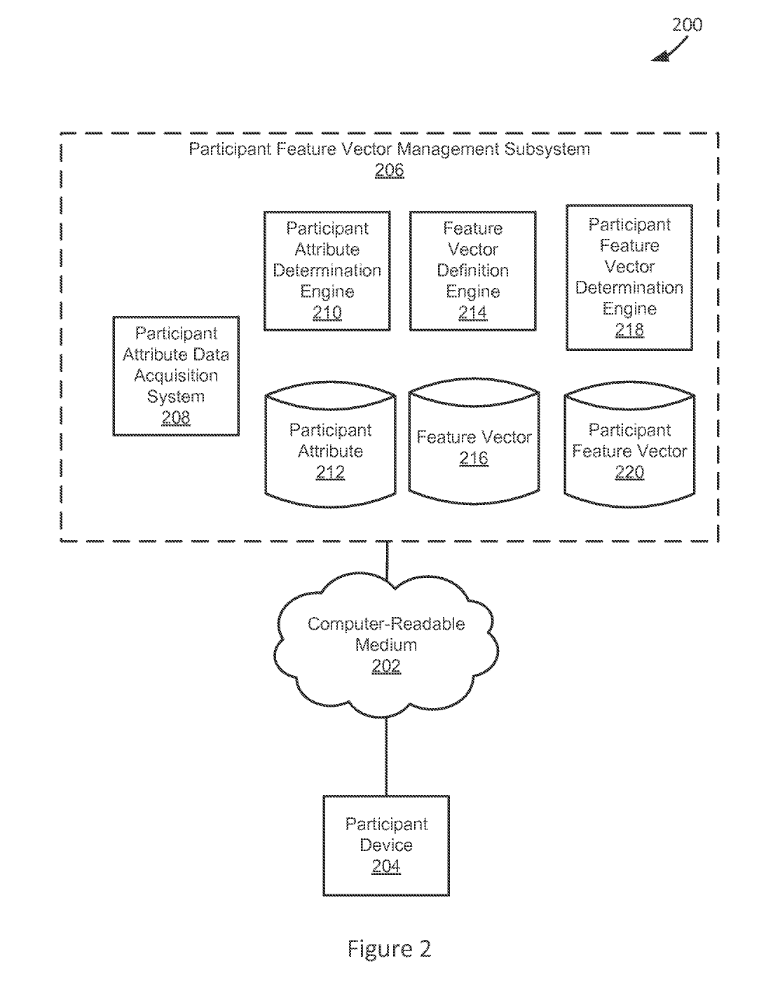

FIG. 2 depicts a diagram 200 of an example of a system for generating a feature vector for a participant. The example system shown in FIG. 2 includes a computer-readable medium 202, a participant device 204, and a participant feature vector management subsystem 206. In the example system shown in FIG. 2, the participant device 204 and the participant feature vector management subsystem 206 are coupled to each other through the computer-readable medium 202.

In a specific implementation, the participant device 204 functions according to an applicable device for sending and receiving data used in interacting with products, such as the participant devices described in this paper. Depending upon implementation-specific or other considerations, the participant device 204 can be used in generating and/or sending participant data to the participant feature vector management subsystem 206. Depending upon implementation-specific or other considerations, participant data can be input to the participant device 204 through a web portal. Participant data can be used to determine a feature vector for a participant. Further depending upon implementation-specific or other considerations, participant data can be generated for participants in response to input triggers perceived by a participant or interactions with products by the participant. For example, an input trigger can be a question whether a participant likes a specific product or expresses a desire for the specific product, and participant data can indicate an answer as to whether the participant likes the specific product or expresses a desire for the specific product. The participant device 204 can be a thin client or an ultra-thin client.

In a specific implementation, the participant feature vector management subsystem 206 functions according to an applicable system for determining at least one feature vector for a participant, such as the participant feature vector management subsystems described in this paper. The participant feature vector management subsystem 206 can determine a feature vector for a participant based on participant data received from the participant device 204. Depending upon implementation-specific or other considerations, the participant feature vector management system 206 can determine attributes of a participant from participant data received from the participant. Further depending upon implementation-specific or other considerations, the participant feature vector management subsystem 206 can define a feature vector to include a number of specific attributes. For example, the participant feature vector management subsystem 206 can define a feature vector to include attributes related to a face of a participant. Depending upon implementation-specific or other considerations, the participant feature vector management subsystem 206 can determine a feature vector for a participant based on a defined feature vector and determined attributes of the participant.

In the example system shown in FIG. 2, the participant feature vector management subsystem 206 includes a participant attribute data acquisition system 208, a participant attribute determination engine 210, a participant attribute datastore 212, a feature vector definition engine 214, a feature vector datastore 216, a participant feature vector determination engine 218, and a participant feature vector datastore 220. In a specific implementation, the participant attribute data acquisition system 208 functions to collect participant data used in determining attributes of a participant. In collecting participant data, the participant attribute data acquisition system 208 can send input triggers to the participant device 204 that when perceived cause a participant to input data used in generating participant data. For example, the participant attribute data acquisition system 208 can send a survey to the participant device 204 that causes a participant to provide answers to the survey included as part of participant data. Depending upon implementation-specific or other considerations, the participant attribute data acquisition system 208 can send input triggers to the participant device 204 based on an applicable combination of previous input triggers sent to the participant device 204, determined attributes of a participant, a feature vector for a participant, a product to which a participant has been mapped, a portrait to which a participant has been mapped, and a cluster to which a participant has been mapped.

In a specific implementation, the participant attribute determination engine 210 functions to determine participant attributes of a participant. The participant attribute determination engine 210 can determine participant attributes from participant data retrieved by the participant attribute data acquisition system 208. Attributes of a participant can include features, characteristics, and traits defining a participant. For example, attributes of a participant can include an age and sex of the participant. Depending upon implementation-specific or other considerations, attributes of a participant can include products a participant uses. Attributes of a participant can serve as market segmentation variables used to segment participants into groups. Examples of market segmentation variables can include geographic, demographic, psychographic, behavioristic, and/or other data about one or more market segments.

In a specific implementation, the participant attribute datastore 212 functions to store participant attribute data indicating attributes of a participant. Participant attribute data can include an identification of a participant and corresponding attributes of the participant. Participant attribute data stored in the participant attribute datastore 212 can include attributes of a participant, as determined by the participant attribute determination engine 210. For example, if the participant attribute determination engine 210 determines an attribute of a participant is blonde hair, then participant attribute data for the participant stored in the participant attribute datastore 212 can indicate that the participant has the attribute of blonde hard.

In a specific implementation, the feature vector definition engine 214 functions to define feature vectors that can be applied to a participant to create a participant feature vector for the participant. The feature vector definition engine 214 can define a feature vector to include an applicable number of participant attributes. For example, the feature vector definition engine 214 can define a feature vector to include attributes of a participants face. Depending upon implementation-specific or other considerations, the feature vector definition engine 214 can define a feature vector to include one or a plurality of domains. A domain can include an organizational group into which an attribute can be categorized. For example, if an attribute defines a participant's nose, then the domain for the attribute can be a body categorization of the participant. In another example, if an attribute defines a participant's shopping tendencies, then the domain for the attribute can be a mental classification of the participant. Further depending upon implementation-specific or other considerations, the feature vector definition engine 214 can define a feature vector to include one or a plurality of classes. A class can include an organizational group serving as a subset within a domain, into which an attribute can be categorized. For example, if a domain for an attribute is a body categorization, and the attribute described a feature of a participant's nose, then the class can be a nose categorization. A feature vector defined by the feature vector definition engine 214 can include an attribute field in which an attribute value indicating an attribute of a participant can be included. An attribute field included in a feature vector can be categorized into a domain and/or a class. Depending upon implementation-specific or other considerations, an attribute field can exist in a plurality of feature vectors in either or both different domains and classes of the feature vectors.

In a specific implementation, the feature vector datastore 216 functions to store feature vector data including a feature vector data structure. The feature vector datastore 216 can store feature vector data for a feature vector defined by the feature vector definition engine 214. Depending upon implementation-specific or other considerations, a feature vector data structure stored in the feature vector datastore 216 can include a domain in which participant attributes are categorized in a feature vector. Further depending upon implementation-specific or other considerations, a feature vector data structure stored in the feature vector datastore 216 can include a class in which participant attributes are categorized in a feature vector. Depending upon implementation-specific or other considerations, a feature vector data structure stored in the feature vector datastore 216 can include an attribute field capable of being populated with a value indicating an attribute of a participant.

In a specific implementation, the participant feature vector determination engine 218 functions to determine a feature vector for a participant. The participant feature vector determination engine 218 can determine a feature vector for a participant based on a feature vector stored in the feature vector datastore 216, as determined by the feature vector definition engine 214. Additionally, the participant feature vector determination engine 218 can determine a feature vector for a participant based on attributes for a participant stored in the participant attribute datastore 212, as determined by the participant attribute determination engine 210. For example, the participant feature vector determination engine 218 can fill in attribute fields in a feature vector defined by the feature vector definition engine 214 according to attributes of a participant, as determined by the participant attribute determination engine 210, to generate a feature vector for the participant. For example, if a feature vector includes an attribute field for whether a participant is single, and the participant attribute determination engine 210 determines the participant is single, then the participant feature vector determination engine 218 can populate the attribute field in a participant feature vector with a value indicating the participant is single.

In a specific implementation, the participant feature vector datastore 220 functions to store participant feature vector data including a feature vector for a participant. Participant feature vector data can include a participant feature vector data structure. A participant feature vector data structure can include classes, domains, and attribute fields populated with values according to determined attributes of a participant. The participant feature vector datastore 220 can store participant feature vector data determined by the participant feature vector determination engine 218.

In an example of operation of the example system shown in FIG. 2, the participant attribute data acquisition system collects participant data from the participant device 204. In the example of operation of the example system shown in FIG. 2, the participant attribute determination engine determines attributes of a participant from the participant data collected by the participant attribute data acquisition system 208. Further, in the example of operation of the example system shown in FIG. 2, the participant attribute datastore 212 stored participant data indicating the attributes of the participant determined by the participant attribute determination engine 210. In the example of operation of the example system shown in FIG. 2, the feature vector definition engine 214 defines a feature vector used in creating a participant feature vector for the participant. Additionally, in the example of operation of the example system shown in FIG. 2, the feature vector datastore 216 stores feature vector data indicating a feature vector defined by the feature vector definition engine 214. In the example of operation of the example system shown in FIG. 2, the participant feature vector determination engine 218 generates a participant feature vector for the participant based on the feature vector defined by the feature vector definition engine 214 and the attributes of the participant determined by the participant attribute determination engine 210. Further, in the example of operation of the example system shown in FIG. 2, the participant feature vector datastore 220 stores participant feature vector data indicating the participant feature vector determined by the participant feature vector determination engine 218.

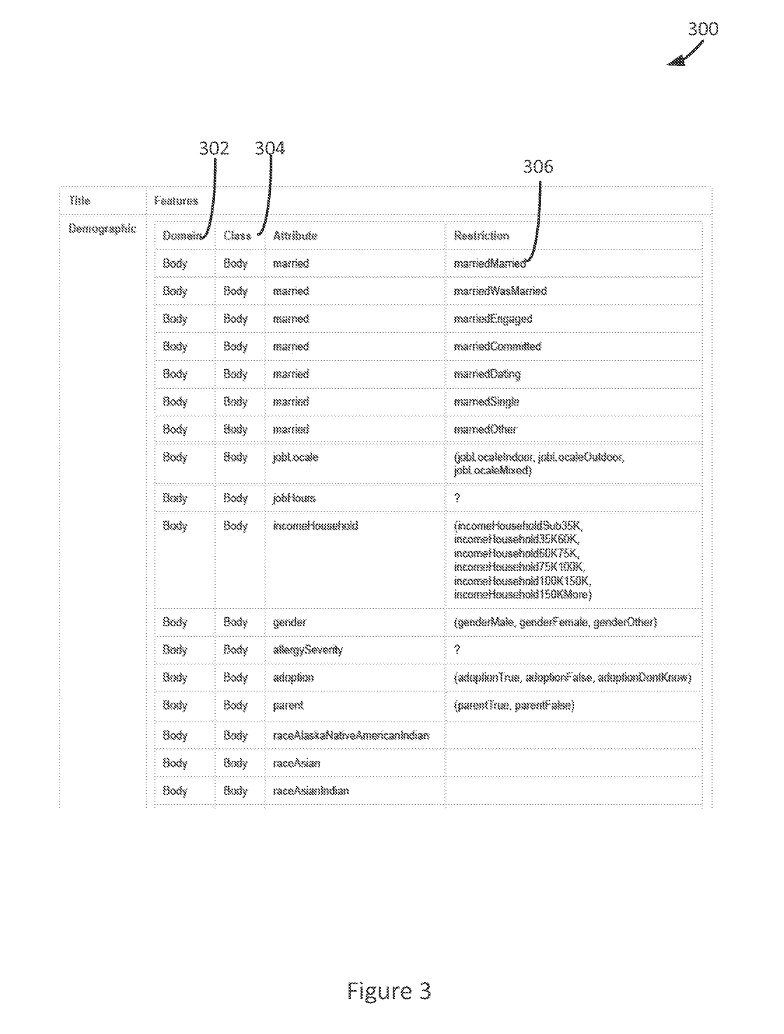

FIG. 3 depicts a diagram 300 of an example of a feature vector data structure. The example feature vector data structure shown in FIG. 3 includes a domain 302, a class 304, and a plurality of fields 306 capable of being populated to indicate an attribute of a participant. In the example feature vector data structure shown in FIG. 3, the domain is the body domain. Depending upon implementation-specific or other considerations, a domain in a feature vector data structure can be a product, including both tangible items and services. The class 304 is a categorization serving as a subset within the domain 302. In the example feature vector data structure shown in FIG. 3, the class is a body subset. In the example feature vector data structure shown in FIG. 3, the fields 306 include fields indicating a relationship status of a participant. The fields 306 can be populated according to the relationship status of a participant, corresponding to an attribute of the participant. For example, if a participant is currently married, then the field indicating that a participant is married can be populated to signify the participant is married.

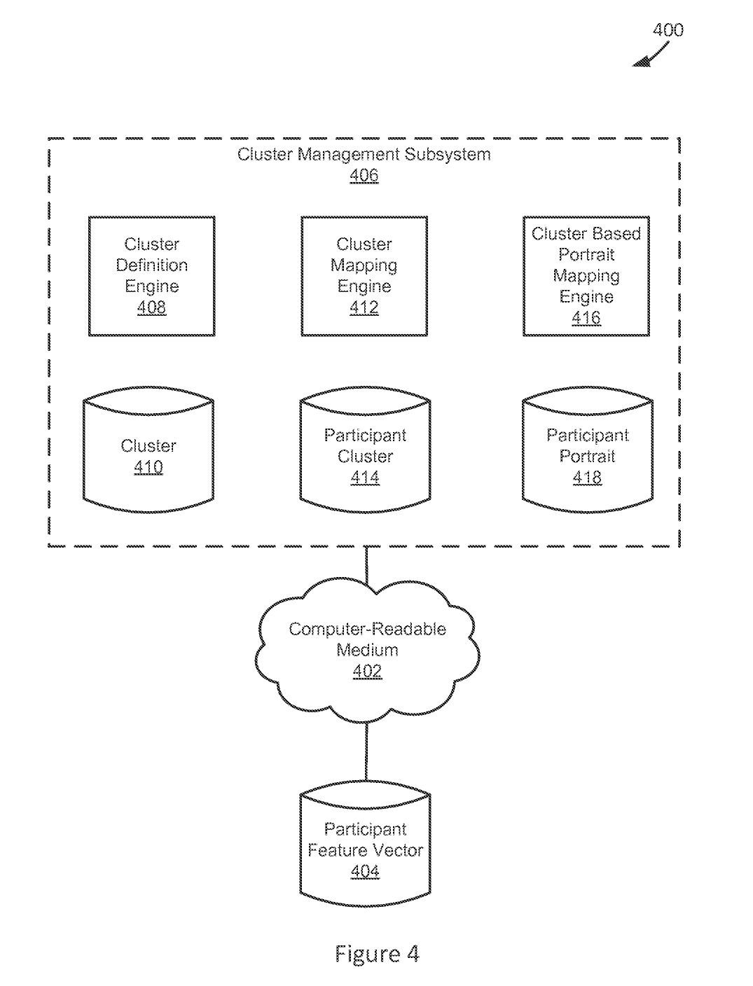

FIG. 4 depicts a diagram 400 of an example of a system for mapping a participant to a portrait using a participant feature vector for the participant. The example system shown in FIG. 4 includes a computer-readable medium 402, a participant feature vector datastore 404, and a cluster management subsystem 406. In the example system shown in FIG. 4, the participant feature vector datastore 404 and the cluster management subsystem 406 are coupled to each other through the computer-readable medium 402.

In a specific implementation, the participant feature vector datastore 404 functions according to an applicable datastore for storing participant feature vectors of a participant, such as the participant feature vector datastores described in this paper. A participant feature vector stored in the participant feature vector datastore 404 can be generated by an applicable system for generating participant feature vectors, such as the participant feature vector management subsystems described in this paper. Depending upon implementation-specific or other considerations, a participant feature vector stored in the participant feature vector datastore 404 can be generated using a defined feature vector. Further depending upon implementation-specific or other considerations, a participant feature vector stored in the participant feature vector datastore 404 can be generated based on determined attributes of a participant. Further depending upon implementation-specific or other considerations, a participant feature vector stored in the participant feature vector datastore can be stored as participant feature vector data, which includes a domain and/or a class used in categorizing attributes of a participant.

In a specific implementation, the cluster management subsystem 406 functions according to an applicable system for mapping a participant to a portrait based on a participant feature vector of the participant, such as the cluster management subsystems described in this paper. In mapping a participant to a portrait, the cluster management subsystem 406 can function to define a cluster. A cluster can include a subset of participants grouped together according to one or a plurality of attributes shared by the participants in the cluster, the attributes of the participant in the cluster thereby defining the cluster. For example, a cluster can include all participants with blue eyes. Depending upon implementation-specific or other considerations, a cluster can be defined according to an applicable number of attributes of participants. For example, a cluster can be defined based on a single attribute or a plurality of attributes. Further depending upon implementation-specific or other considerations, a cluster can be defined based on related attributes of participants. Attributes can be related based on portions of the body that the attributes describe, traits of participants that the attributes describe, and/or products that are associated with each other and described by the attributes. For example, attributes can be related if they describe the skin of a participant.

In a specific implementation, the cluster management subsystem 406 can map a participant to a portrait by mapping the participant to a cluster. Depending upon implementation-specific or other considerations, the cluster management subsystem 406 can map a participant to a defined cluster. Further depending upon implementation-specific or other considerations, the cluster management subsystem 406 can map a participant to a portrait based on clusters to which a participant is mapped and portraits that include the clusters. For example if a participant is mapped to a cluster included in a specific portrait, then the cluster management subsystem 406 can map the participant to the specific portrait.

In the example system shown in FIG. 4, the cluster management subsystem 406 includes a cluster definition engine 408, a cluster datastore 410, a cluster mapping engine 412, a participant cluster datastore 414, a cluster based portrait mapping engine 416, and a participant portrait datastore 418. In a specific implementation, the cluster definition engine 408 functions to define a cluster to which a participant can be mapped. In defining clusters, the cluster definition engine 408 can define a cluster according to attributes of participants. The cluster definition engine 408 can define a cluster to include participants who share the same attributes or have related attributes. For example, the cluster definition engine 408 can define a cluster to include men between the ages of 25-30 years old and having brown hair. Depending upon implementation-specific or other considerations, the cluster definition engine 408 can dynamically define and change clusters according to either or both discovery of new attributes of participants, and success of interactions with products by participants mapped to the products through mapping to the clusters.

In a specific implementation, the cluster datastore 410 functions to store cluster data indicating defined clusters. Cluster data stored in the cluster datastore 410 can indicate clusters defined by the cluster definition engine 408. Depending upon implementation-specific or other considerations, cluster data stored in the cluster datastore 410 can include attributes that define a cluster. For example, if a cluster is defined by blue eyes, then cluster data for the cluster can indicate that the cluster requires participants to have blue eyes.

In a specific implementation, the cluster mapping engine 412 functions to map a participant to a cluster. The cluster mapping engine 412 can map a participant to a cluster defined by the cluster definition engine 408 and indicated by cluster data stored in the cluster datastore 410. In mapping a participant to a cluster, the cluster mapping engine 412 can utilize one or a plurality of feature vectors of a participant, as stored in the participant feature vector datastore 404. Specifically, the cluster mapping engine 412 can map a participant to a cluster based on attributes of the participant, as indicated by the participant feature vector for the participant. For example, if a participant feature vector of a participant indicates that a participant has blue eyes, then the cluster mapping engine 412 can map the participant to a cluster that requires blue eyes. Depending upon implementation-specific or other considerations, the cluster mapping engine 412 can map a participant to a cluster based on a plurality of attributes of the participant. For example, if a participant has dark hair and blue eyes, then the cluster mapping engine 412 can map the participant to a cluster that requires dark hair and blue eyes. Further depending upon implementation-specific or other considerations, the cluster mapping engine 412 can map a participant to a plurality of clusters based on attributes of the participant. Depending upon implementation-specific or other considerations, a plurality of clusters to which a participant is mapped can have shared attributes that define the clusters.

In a specific implementation, the participant cluster datastore 414 functions to store participant cluster data indicating clusters to which participants are mapped. Participant cluster data stored in the participant cluster datastore 414 can indicate clusters to which the cluster mapping engine 412 maps a participant. Depending upon implementation-specific or other considerations, participant cluster data can include an identification of a participant mapped to clusters. An identification of a participant can be obtained from a participant feature vector of a participant, as included as part of participant feature vector data stored in the participant feature vector datastore 404.

In a specific implementation, the cluster based portrait mapping engine 416 functions to map a participant to a portrait based on one or a plurality of clusters to which the participant has been mapped. A portrait can include a plurality of clusters and is defined by the attributes of participants in the plurality of clusters. The cluster based portrait mapping engine 416 can map a participant to a portrait based on participant cluster data stored in the participant cluster datastore 414. For example, if a participant is in a cluster of participants with blue eyes and in another cluster of participants with brown hair, then the cluster based portrait mapping engine 416 can map the participant to a portrait that includes the cluster of participants with brown hair and the cluster of participants with blue eyes. Attributes of participant defining clusters included in a portrait can define the portrait. Depending upon implementation-specific or other considerations, a participant can take on a specific attribute defining a portrait to which the participant is mapped, even if it unknown whether the participant has the specific attribute. For example, if a participant is mapped to a portrait that is defined by participant attributes including green eyes, and it is unknown what the eye color of the participant is, then it can be assumed that the participant has green eyes.

In a specific implementation, clusters included in a portrait can continually evolve. Depending upon implementation-specific or other considerations, clusters included in a portrait can change based on whether participants mapped to the portrait actually have attributes defining the clusters included in the portrait. For example, if a participant is mapped to a portrait including a cluster defined by the attribute of having green eyes, and it is discovered that the participant does not have green eyes, then the cluster can be removed, or otherwise disassociated, with the portrait. Further depending upon implementation-specific or other considerations, clusters included in a portrait can change based on success of advertising products to participants mapped to the portrait. For example, if participants are not interested in products advertised to them according to a portrait the participants have been mapped to, then the clusters included in the portrait can be changed in order to achieve greater success in advertising products.

In a specific implementation, the cluster based portrait mapping engine 416 can dynamically map a participant to different portraits. The cluster based portrait mapping engine 416 can map a participant to a new portrait based on previous portraits to which the participant is mapped. Depending upon implementation-specific or other considerations, the cluster based portrait mapping engine 416 can map a participant to a new portrait after more attributes of the participant are discovered. In mapping a participant to a new portrait after discovery of more attributes for the participant, the cluster based portrait mapping engine 416 can use, at least in part, the newly discovered attributes to map the participant to the new portrait. For example, if it is discovered that a participant has brown hair, then the cluster based portrait mapping engine 416 can map the participant to a new portrait based on the discovery that the participant has brown hair. Further depending upon implementation-specific or other considerations, the cluster based portrait mapping engine 416 can map a participant to a newly defined portrait. A newly defined portrait can be created specifically for a participant based on attributes of the participant. Depending upon implementation-specific or other considerations, the cluster based portrait mapping engine 416 can map a participant to a new portrait based on success of advertising products to the participant. For example, if the participant is not interested in products advertised according to a portrait the participant has been mapped to, then the participant can be mapped to a new portrait.

In a specific implementation, the participant portrait datastore 418 functions to store participant portrait data indicating a portrait to which a participant has been mapped. Participant portrait data stored in the participant portrait datastore 418 can include a portrait to which the cluster based portrait mapping engine 416 maps a participant. Depending upon implementation-specific or other considerations, participant portrait can include an identification of a participant mapped to a portrait. An identification of a participant can be obtained from a participant feature vector of a participant, as included as part of participant feature vector data stored in the participant feature vector datastore 404. Further depending upon implementation-specific or other considerations, participant portrait data can include a history or list of a plurality of portraits to which a participant has been mapped.

In an example of operation of the example system shown in FIG. 4, the participant feature vector datastore 404 stores a participant feature vector for a participant. In the example of operation of the example system shown in FIG. 4, the cluster definition engine 408 defines clusters. Further, in the example of operation of the example system shown in FIG. 4, the cluster datastore 410 stores cluster data indicating the clusters defined by the cluster definition engine 408. In the example of operation of the example system shown in FIG. 4, the cluster mapping engine 412 maps the participant to the clusters based on the participant feature vector of the participant. Additionally, in the example of operation of the example system shown in FIG. 4, the participant cluster datastore 414 stores participant cluster data indicating the clusters to which the participant is mapped by the cluster mapping engine 412. In the example of operation of the example system shown in FIG. 4, the cluster based portrait mapping engine 416 maps the participant to a portrait based on the clusters to which the participant is mapped. Further, in the example of operation of the example system shown in FIG. 4, the participant portrait datastore 418 stores participant portrait data indicating the portrait to which the participant is mapped.

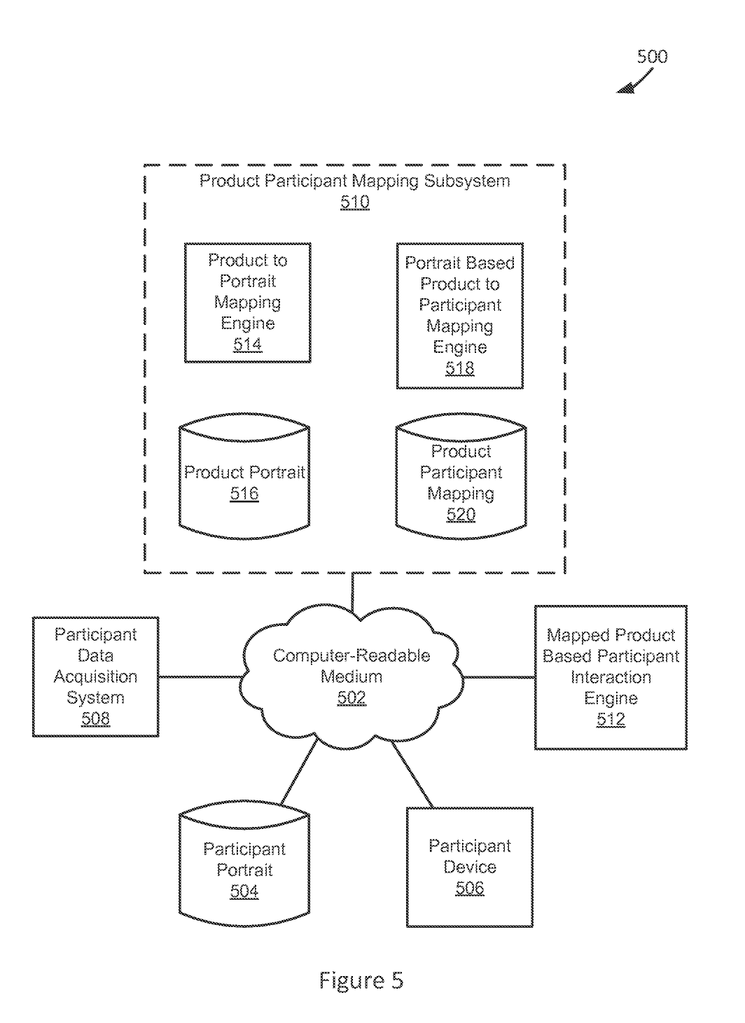

FIG. 5 depicts a diagram 500 of an example of a system for mapping products to a participant based on portraits. The example system shown in FIG. 5 includes a computer-readable medium 502, a participant portrait datastore 504, a participant device 506, a participant data acquisition system 508, a product participant mapping subsystem 510, and a mapped product based participant interaction engine 512. In the example system show in FIG. 5, the participant portrait datastore 504, the participant device 506, the participant data acquisition system 508, the product participant mapping subsystem 510, and the mapped product based participant interaction engine 512 are coupled to each other through the computer-readable medium 502.

In a specific implementation, the participant portrait datastore 504 functions according to an applicable datastore for storing participant portrait data indicating portraits to which participants have been mapped, such as the participant portrait datastores described in this paper. A portrait, to which a participant has been mapped, as indicated by participant portrait data, can be determined based on attributes of the participant included in a participant feature vector. Depending upon implementation-specific or other considerations, participant portrait data can include an identification of a participant, a MAC address of a participant device used by the participant, and/or an IP address assigned to the participant device.

In a specific implementation, the participant device 506 functions according to an applicable device through which a participant can generate participant data, such as the participant devices described in this paper. Participant data generated through the participant device 506 can be used to map a participant to a portrait based on attributes of the participant. Participant data can be generated by a user interacting with products, or reacting to input triggers at the participant device 506. Depending upon implementation-specific or other considerations, in interacting with products, a participant can view displays or advertisements of products that a participant might be willing to purchase, purchase a product, or reject purchasing a product. Further depending upon implementation-specific or other considerations, a participant device 506 can function to support a web portal in which a participant can interact to generate participant data.

In a specific implementation, the participant data acquisition system 508 functions according to an applicable system for collecting participant data from the participant device 506, such as the participant data acquisition systems described in this paper. In acquiring participant data, the participant attribute data acquisition system 508 can send input triggers to the participant device 506 that when perceived cause a participant to input data used in generating participant data. For example, the participant attribute data acquisition system 508 can send a survey to the participant device 508 that causes a participant to provide answers to the survey included as part of participant data. Depending upon implementation-specific or other considerations, the participant attribute data acquisition system 508 can send input triggers to the participant device 506 based on an applicable combination of previous input triggers sent to the participant device 506, determined attributes of a participant, a feature vector for a participant, a product to which a participant has been mapped, a portrait to which a participant has been mapped, and a cluster to which a participant has been mapped. Further depending upon implementation-specific or other considerations, the participant data acquisition system can collect participant data indicating how a participant interacted with a participant. For example, if a participant decided to purchase a product after viewing an advertisement of the product, the participant data acquisition system 508 can collect participant data indicating that the participant decided to purchase the product in response to the advertisement of the product.

In a specific implementation, the product participant mapping subsystem 510 functions according to an applicable system for mapping participants to products based on portraits to which the participants are mapped, such as the product participant mapping subsystems described in this paper. In mapping products to a participant based on a portrait, the product participant mapping subsystem 510 can map a participant to a product if the product has been mapped to a specific portrait, and the specific portrait has been mapped to the participant. Additionally, in mapping products to a participant based on a portrait, the product participant mapping subsystem 510 can map products to specific portraits based on how participants mapped to the specific portraits have interacted with the products. Depending upon implementation-specific or other considerations, the product participant mapping subsystem 510 can map a product to a portrait if participants mapped to the portrait have indicated a liking of the product, as included as part of participant data collected by the participant data acquisition system 508. Further depending upon implementation-specific or other considerations, the product participant mapping subsystem 510 can map a product to a portrait if participants mapped to the portrait have purchased the product in response to advertising of the product, as included as part of participant data collected by the participant data acquisition system 508.

In a specific implementation, the product participant mapping subsystem 510 maps products to specific portraits based on attributes of participants defining clusters included in the portraits, and/or attributes of participants defining the portraits. For example, if the product participant mapping subsystem 510 determines that a product should be advertised to males between 25-30 years old, then the product participant mapping subsystem 510 can map the product to portraits including clusters defined by participants who are males between the ages of 25-30 years old. Depending upon implementation-specific or other considerations, the product participant mapping subsystem 510 can map a product to a portrait based on input from either or both an administrator, developer, or provider of a product. For example, if a developer of a product determines that a product should be targeted to females between the ages of 25-30 years old, then the product participant mapping subsystem 510 can map the product to portraits including clusters defined by females between the ages of 25-30 years old.

In a specific implementation, the mapped product based participant interaction engine 512 functions to provide functionalities to a participant in interacting with a product mapped to the participant based on a portrait to which the participant is mapped. The mapped product based participant interaction engine 512 can provide functionalities to a participant in interacting with a product mapped to the participant by the product participant mapping subsystem 510. Depending upon implementation-specific or other considerations, in providing functionalities in which a participant can interact with a product, the mapped product based participant interaction engine 512 can present an advertisement of the product to a participant through the participant device 506. The mapped product based participant interaction engine 512 can advertise a product to a participant according to instructions received from a developer and/or supplier of the product. For example, if a developer of a product specifies to advertise the product using a specific image of the product, then the mapped product based participant interaction engine can present the specific image of the product to a participant. Further depending upon implementation-specific or other considerations, the mapped product based participant interaction engine 512 can advertise a product according to interactions by a participant with the product. For example, if a participant does not buy a product, then the mapped product based participant interaction engine 512 can stop advertising the product to the participant. Further depending upon implementation-specific or other considerations, in providing functionalities in which a participant can interact with a product, the mapped product participant interaction engine 512 can provide an interface to the participant using the participant device 506 through which the participant can purchase the product.

In the example system shown in FIG. 5, the product participant mapping subsystem 510 includes a product to portrait mapping engine 514, a product portrait datastore 516, a portrait based product to participant mapping engine 518, and a product participant mapping datastore 520. In a specific implementation, the product to portrait mapping engine 514 functions to map a product to a portrait. The product to portrait mapping engine 514 can map a product to one or a plurality of portraits. The product to portrait mapping engine 514 can map products to specific portraits based on how participants mapped to the specific portraits have interacted with the products. Depending upon implementation-specific or other considerations, the product to portrait mapping engine 514 can map a product to a portrait if participants mapped to the portrait have indicated a liking of the product, as included as part of participant data collected by the participant data acquisition system 508. Further depending upon implementation-specific or other considerations, the product to portrait mapping engine 514 can map a product to a portrait if participants mapped to the portrait have purchased the product in response to advertising of the product, as included as part of participant data collected by the participant data acquisition system 508.

In a specific implementation, the product to portrait mapping engine 514 can map a product to a portrait based on related products to the product. Products can be related if they share a same target audience, perform a related or the same function, and/or are developed by the same or related developers or manufacturers. Depending upon implementation-specific or other considerations, in mapping a product to a portrait based on related products to the product, the product to portrait mapping engine 514 can map the product to the same portraits to which the related product have been mapped. For example if a first shampoo is mapped to a specific portrait, then a second shampoo can be mapped to the specific portrait as well. Further depending upon implementation-specific or other considerations, in mapping a product to a portrait based on related products to the product, the product to portrait mapping engine 514 can map the product to a portrait based on the success in participant interactions of the related products within the portrait. Success in participant interactions can include either or both, whether participants are purchasing a product and whether participants indicate they like or express as desire for the product. For example, if a first shampoo is selling to participants in a specific portrait, then the product to portrait mapping engine 514 can map a second shampoo to the specific portrait.

In a specific implementation, the product to portrait mapping engine 514 maps products to specific portraits based on attributes of participants defining clusters included in the portraits, and/or attributes of participants defining the portraits. For example, if the product to portrait mapping engine 514 determines that a product should be advertised to males between 25-30 years old, then the product to portrait mapping engine 514 can map the product to portraits including clusters defined by participants who are males between the ages of 25-30 years old. Depending upon implementation-specific or other considerations, the product to portrait mapping engine 514 can map a product to a portrait based on input from either or both an administrator, developer, or provider of a product. For example, if a developer of a product determines that a product should be targeted to females between the ages of 25-30 years old, then the product to portrait mapping engine 514 can map the product to portraits including clusters defined by females between the ages of 25-30 years old.

In a specific implementation, the product to portrait mapping engine 514 can dynamically map a product to different portraits. The product to portrait mapping engine 514 can map a product to a new portrait based on previous portraits to which the product is mapped. Depending upon implementation-specific or other considerations, the product to portrait mapping engine 514 can map a product to a new portrait based on success of participant interactions with the product within a portrait to which the product is mapped. For example, if participants in a first portrait either or both fail to indicate a liking of a product mapped to the first portrait or fail to purchase the product, then the product can be mapped to a second portrait.

In a specific implementation, the product portrait datastore functions to store product portrait data indicating portraits to which products are mapped. The product portrait datastore 516 can store product portrait data indicating portraits to which product are mapped, as determined by the product to portrait mapping engine 514. Product portrait data stored in the product portrait datastore 516 can include an identification of a specific product and an identification of one or a plurality of portraits to which a product is mapped. Depending upon implementation-specific or other considerations, the product portrait datastore 516 can store product portrait data identifying previous portraits to which a product is mapped.

In a specific implementation, the portrait based product to participant mapping engine 518 functions to map a product to participant based on a portrait. The portrait based product to participant mapping engine 518 can map products to participants based on portraits that the participants have been mapped to and portraits to which the products have been mapped. For example, if a product has been mapped to a specific portrait, then the portrait based product to participant mapping engine 518 can map the product to participant mapped to the specific portrait. In mapping a product to a participant based on portraits the portrait based product to participant mapping engine 518 can utilize product portrait data stored in the product portrait datastore 516 and participant portrait data stored in the participant portrait datastore 504.

In a specific implementation, the product participant mapping engine 520 functions to store product participant mapping data indicating participants to which products are mapped. Product participant mapping data stored in the product participant mapping datastore 520 can include identifications of specific products that have been mapped to participants and identifications of specific participants to which products are mapped. Depending upon implementation specific or other considerations, product participant mapping data can include attributes defining either or both clusters and portraits of participants to which products are mapped.

In an example of operation of the example system shown in FIG. 5, the participant portrait datastore 504 functions to store participant portrait data indicating portraits to which participants are mapped. In the example of operation of the example system shown in FIG. 5, the product to portrait mapping engine 514 maps a product to the portraits. Further, in the example of operation of the example system shown in FIG. 5, the portrait based product to participant mapping engine 518 maps the product to participants mapped to the portraits. In the example of operation of the example system shown in FIG. 5, the mapped product based participant interaction engine 512 manages interaction with the product through the participant device 506 by the participants mapped to the product.

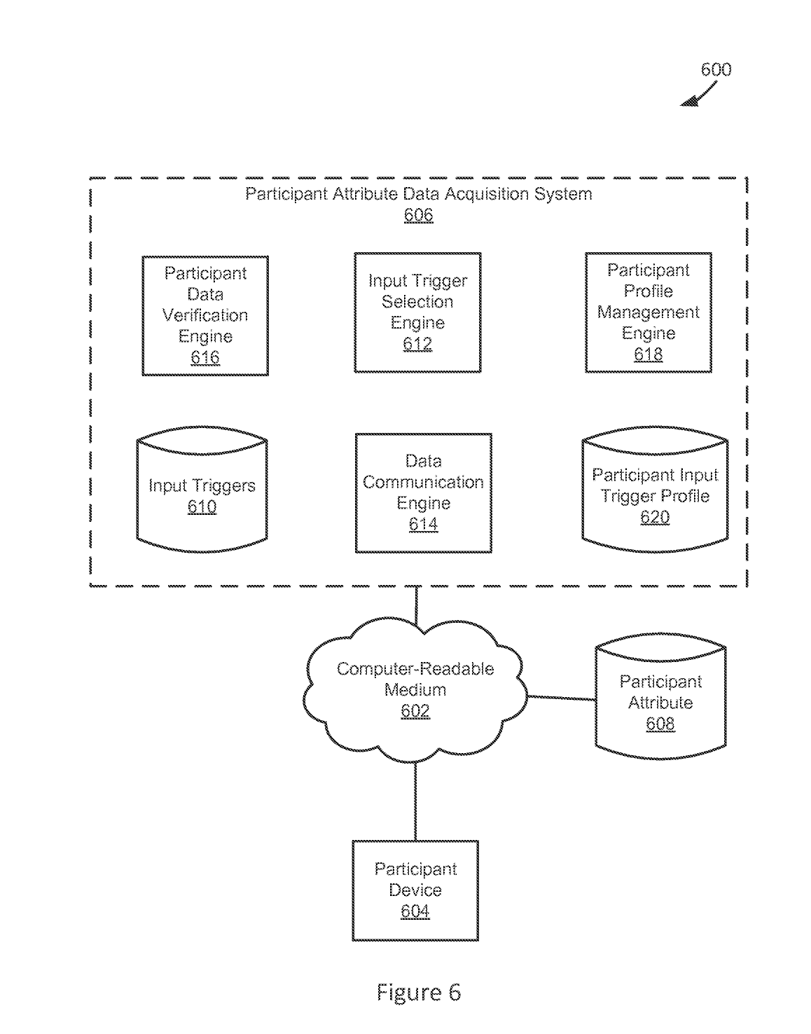

FIG. 6 depicts a diagram 600 of an example of a system for acquiring participant data used in mapping participants to products based on portraits. The example system shown in FIG. 6 includes a computer-readable medium 602, a participant device 604, a participant attribute data acquisition system 606, and a participant attribute datastore 608. In the example system show in FIG. 6, the participant device 604, the participant attribute data acquisition system 606, and the participant attribute datastore 608 are coupled to each other through the computer-readable medium 602.

In a specific implementation, the participant device 604 functions according to an applicable device through which a participant can generate participant data, such as the participant devices described in this paper. Participant data generated through the participant device 604 can be used to map a participant to a portrait based on attributes of the participant. Participant data can be generated by a user interacting with products, or reacting to input triggers at the participant device 604. Depending upon implementation-specific or other considerations, in interacting with products, a participant can view displays or advertisements of products that a participant might be willing to purchase, purchase a product, or reject purchasing a product. Further depending upon implementation-specific or other considerations, a participant device 604 can function to support a web portal in which a participant can interact to generate participant data.

In a specific implementation, the participant attribute data acquisition system 606 functions according to an applicable system for collecting participant data from a participant used to map the participant to a product. Depending upon implementation-specific or other considerations, the participant attribute data acquisition system 606 can send input triggers to the participant device 604 used to generate participant data. The participant attribute data acquisition system 606 can determine input triggers to send to a participant device 604 based on previous input triggers sent to a participant using the participant device 604, and/or clusters, portraits and products to which the participant using the participant device 604 have been mapped. Depending upon implementation-specific or other considerations, the participant attribute data acquisition system 606 can determine input triggers to send to a participant device 604 based on behavior of clusters themselves throughout time. For example, if an input trigger is not performing well for users mapped to a cluster over time, the participant attribute data acquisition system 606 can determine to not send the input trigger to participants mapped to the cluster. Further depending upon implementation-specific or other considerations, the participant attribute data acquisition system 606 functions to determine whether participant data received from the participant device 604 is valid. Validity of participant data can include whether a participant actually perceived an input trigger used to generate the participant data and/or gave a truthful response after perceiving the input trigger.

In a specific implementation, the participant attribute datastore 608 functions according to an applicable datastore for storing participant attribute data indicating participant attributes of a participant, such as the participant attribute datastores described in this paper. Participant attribute data stored in the participant attribute datastore 608 can be determined from participant data collected by the participant attribute data acquisition system 606. Participant attribute data can be generated from participant data from an applicable engine for determining participant attributes, such as the participant attribute determination engines described in this paper. Depending upon implementation-specific or other considerations, participant attribute data stored in the participant attribute datastore 608 can be determined from participant data collected in response to input triggers sent to the participant device 604.

In the example system shown in FIG. 6, the participant attribute data acquisition system 606 includes an input triggers datastore 610, an input trigger selection engine 612, a data communication engine 614, a participant data verification engine 616, a participant profile management engine 618, and a participant input trigger profile datastore 620. In a specific implementation, the input triggers datastore 610 functions to store input trigger data indicating input triggers that can be sent to a participant for acquiring participant data. Depending upon implementation-specific or other considerations, input trigger data stored in the input triggers datastore 610 can include questions to query a participant for determining participant data for the participant. For example, input triggers data stored in the input triggers datastore 610 can specify to ask a participant whether they like or express as desire to purchase a product. In another example, input triggers data stored in the input triggers datastore 610 can specify to ask a participant about their features. Further depending upon implementation-specific or other considerations, input triggers data stored in the input triggers datastore 610 can be used to formulate questions in a quiz presented to a participant.

In a specific implementation, the input trigger selection engine 612 functions to determined input triggers to send to a participant through a participant device 604 used by the participant. The input trigger selection engine 612 can determine input triggers included as part of input triggers data stored in the input triggers datastore 610. Depending upon implementation-specific or other considerations the input trigger selection engine 612 can determine input triggers to send to a participant based on previous input triggers sent to the participant, as indicated by a participant input trigger profile. For example, the input trigger selection engine 612 can determine input triggers to resent to a participant based on a participant input trigger profile. Further depending upon implementation-specific or other considerations, the input trigger selection engine 612 can determine input triggers to send to a participant based on whether participant data received from the participant is valid. Depending upon implementation-specific or other considerations, the input trigger selection engine 612 can determine input triggers to send to a participant based on clusters, portraits and products to which the participant have been mapped. Further depending upon implementation-specific or other considerations, the input trigger selection engine 612 can determine input triggers to send to a participant based on a product of a product giveaway that the participant desires to enter.

In a specific implementation, the data communication engine 614 functions to send and receive data to and from the participant device 604. In sending data to the participant device 604, the data communication engine 614 can send input triggers, as determined by the input trigger selection engine 612, to the participant device 604. In receiving data from the participant device, the data communication engine 614 can receive participant data generated by a participant using the participant device 604. Depending upon implementation-specific or other considerations, participant data received by the data communication engine 614 can be received in response to input triggers perceived by a participant using the participant device 604.

In a specific implementation, the participant data verification engine 616 functions to validate participant data. In validating participant data, the participant data verification engine 616 can determine either or both whether a participant actually perceived an input trigger used to generate the participant data and/or gave a truthful response after perceiving the input trigger. Depending upon implementation-specific or other considerations, the participant data verification engine 616 can determine validity of participant data by comparing it to an expected response for a participant. An expected response for a participant can be determined according to an applicable statistical means, such as k-means clustering. Further depending upon implementation-specific or other considerations, the participant data verification engine 616 can determine validity of participant data for a participant by comparing it to participant data of other participants mapped to the same cluster and/or portrait as the participant. Depending upon implementation-specific or other considerations, the participant data verification engine 616 can determine validity of participant data based on a response time of participant in generating the participant data. For example, if a participant responds to a quiz question quickly, such as to indicate that the participant did not actually perceive the quiz question, then the participant data verification engine 616 can determine that participant data created in response to the participant answering the quiz question is invalid.

In a specific implementation, the data communication engine 614 can communicate to an applicable system for determining participant attributes from participant data whether to determine participant attributes from the participant data. The data communication engine 614 can communicate whether to determine participant attributes from participant data based on whether the participant data verification engine determines that the participant data is valid. For example, the data communication engine 614 can communicate to an applicable system for determining participant attributes from participant data to refrain from determining participant attributes from participant data if the participant data verification engine 616 determines the participant data is invalid.

In a specific implementation, the participant profile management engine 618 functions to manage a participant input trigger profile of a participant. Depending upon implementation-specific or other considerations, a participant input trigger profile can include input triggers that have been sent to a participant and/or whether participant data generated in response to the input triggers is valid. The participant profile management engine 618 can store participant input trigger profiles as participant input trigger profile data in the participant input trigger profile datastore 620. The input trigger selection engine 612 can determine input triggers to send to the participant device based on a participant input trigger profile indicated by participant input trigger profile data stored in the participant input trigger profile datastore 620.

In an example of operation of the example system shown in FIG. 6, the input triggers datastore 610 stores input triggers data indicating input triggers used to generate participant data. In the example of operation of the example system shown in FIG. 6, the input trigger selection engine 612 determines input triggers to send to a participant using the participant device 604. Further, in the example of operation of the example system shown in FIG. 6, the data communication engine 614 sends input triggers from the input triggers data stored in the input triggers datastore 610, as determined by the input trigger selection engine 612, to the participant device. In the example of operation of the example system shown in FIG. 6, the data communication engine 614 receives participant data generated in response to the participant interaction with the input triggers. Additionally, in the example of operation of the example system shown in FIG. 6, the participant data verification engine 616 determines whether the received participant data is valid. In the example of operation of the example system shown in FIG. 6, the participant profile management engine manages a participant input trigger profile for the participant based on the input triggers sent to the participant and the validity of the participant data received in response to the input triggers.

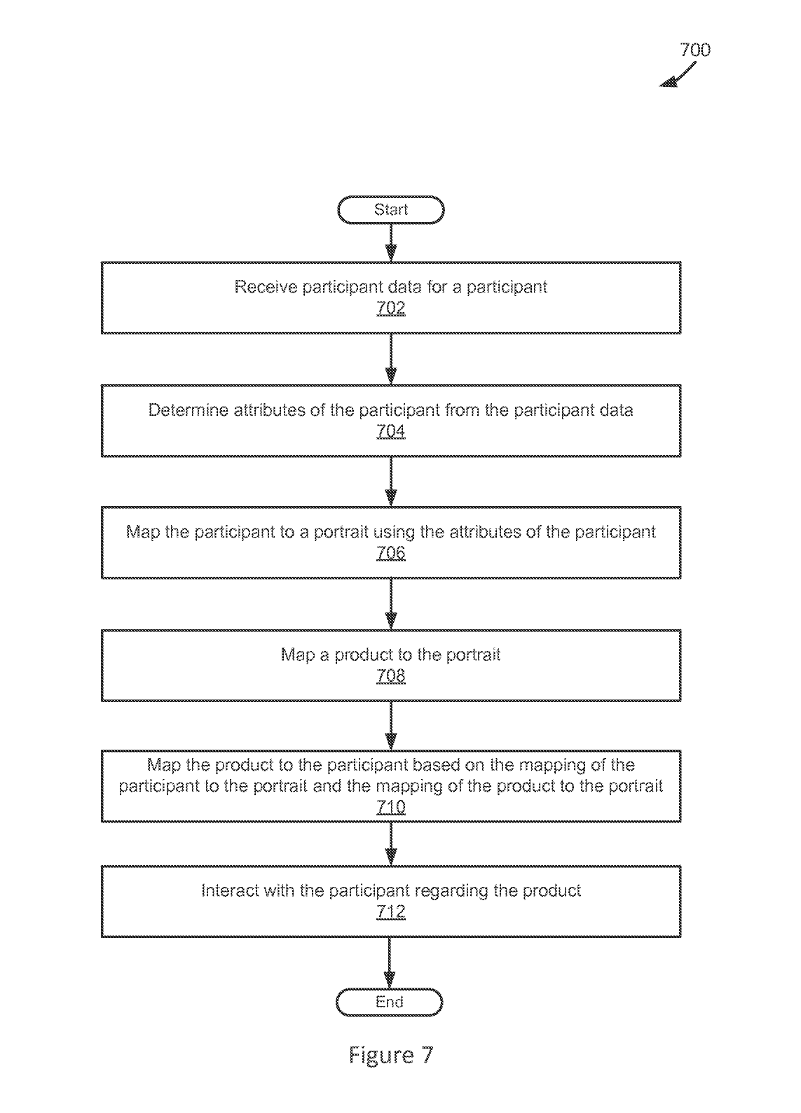

FIG. 7 depicts a flowchart 700 of an example of a method for mapping a product to a participant based on portraits. The flowchart 700 begins at module 702, where participant data for a participant is received. Participant data can be collected by a participant attribute data acquisition system. Participant data can be received in response to interactions with a participant using a participant device. Depending upon implementation-specific or other considerations, participant data can be received based on responses by a participant to input triggers. For example, participant data can be received based on responses by a participant to a quiz that includes questions as input triggers. In another example, participant data can be received based on responses by a participant to advertisements of products included as input triggers.

The flowchart 700 continues to module 704, where attributes of the participant are determined from the participant data. Attributes of a participant can be determined form participant data by a participant attribute determination engine. Attributes of a participant can include features, characteristics, and traits defining a participant. For example, attributes of a participant can include an age and sex of the participant. Depending upon implementation-specific or other considerations, attributes of a participant can include products a participant uses. Attributes of a participant can serve as market segmentation variables used to segment participants into groups. Examples of market segmentation variables can include geographic, demographic, psychographic, behavioristic, and/or other data about one or more market segments.

The flowchart 700 continues to module 706, where the participant is mapped to a portrait using the attributes of the participant. In mapping the participant to a portrait a participant can be mapped to a cluster included as part of a portrait. Depending upon implementation-specific or other considerations, a participant can be mapped to a cluster using a participant feature vector of the participant created using the attributes of the participant. A cluster management subsystem can function to map the participant to a portrait. Depending upon implementation-specific or other considerations, a cluster mapping engine can function to map the participant to a cluster, and a cluster based portrait mapping engine can function to map the participant to a portrait based on the cluster. A portrait to which the participant is mapped to can be defined by participant attributes of participants mapped to the portrait.

The flowchart 700 continues to module 708, where a product is mapped to the portrait. A product can be mapped to the portrait by a product to portrait mapping engine. Depending upon implementation-specific or other considerations, a product can be mapped to the portrait based on participant attributes of target participants to a product. Target participants of a product can include participants who are expected to like or purchase the product, and/or participants who do like or purchase the product. Further depending upon implementation-specific or other considerations, a product can be mapped to the portrait based on interactions with the product by participants in portraits to which related products are mapped. For example, if related products are have successful interactions amongst portraits to which the related products are mapped, then a product can be mapped to the portraits to which the related products are mapped. Depending upon implementation-specific or other considerations, the product can be dynamically mapped to the portrait, wherein the portrait is a new portrait to which the product is mapped.

The flowchart 700 continues to module 710, where the product is mapped to the participant based on the mapping of the participant to the portrait and the mapping of the product to the portrait. A portrait based product to participant mapping engine can map the product to the participant based on the portrait. The portrait based product to participant mapping engine can map products to participants based on portraits that the participants have been mapped to and portraits to which the products have been mapped. For example, if a product has been mapped to a specific portrait, then the portrait based product to participant mapping engine can map the product to participant mapped to the specific portrait.

The flowchart 700 continues to module 712, where the participant is interacted with regarding the product. A mapped product based participant interaction engine can manage interactions with the product by the participant. In interacting with the participant regarding the product, functionalities can be provided to the participant for interacting with the product. Depending upon implementation-specific or other considerations, in providing functionalities in which the participant can interact with the product, an advertisement of the product can be presented to the participant. Further depending upon implementation-specific or other considerations, in providing functionalities in which the participant can interact with a product, an interface can be presented to the participant through which the participant can purchase the product and or express an interest in or a liking of the product.

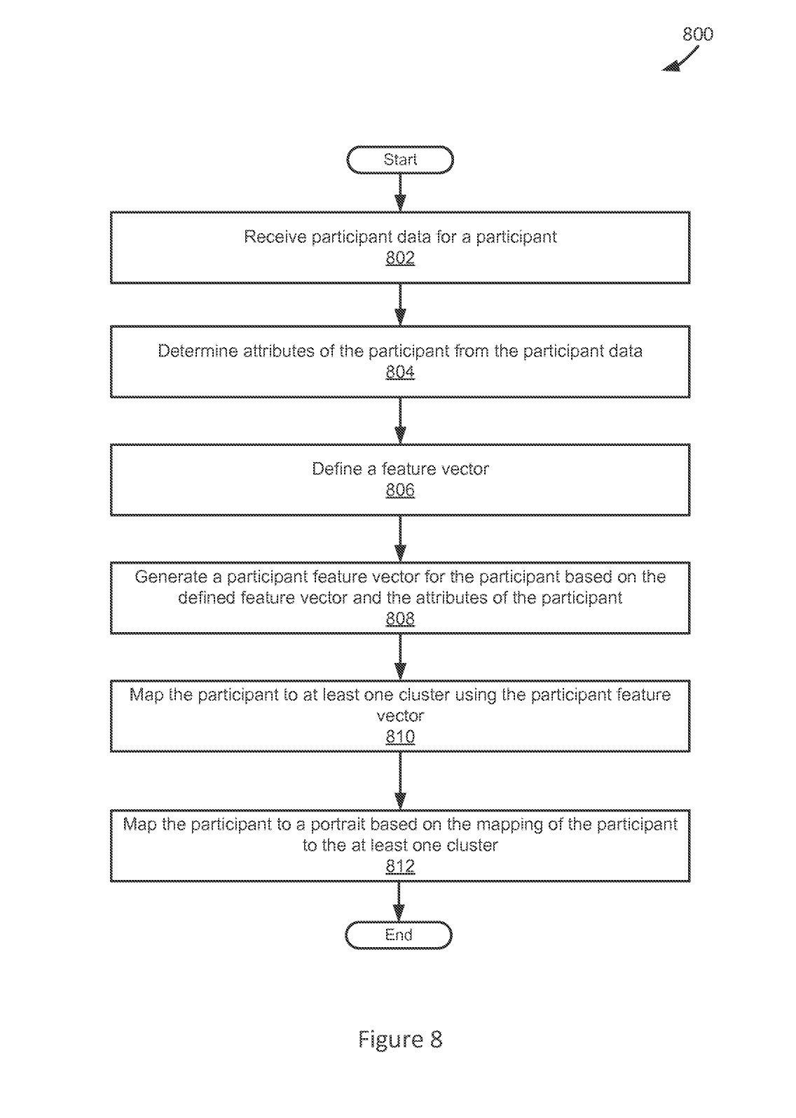

FIG. 8 depicts a flowchart 800 of an example of a method for mapping a participant to a portrait based on attributes of the participant. The flowchart 800 begins at module 802, where participant data for a participant is received. Participant data can be collected by a participant attribute data acquisition system. Participant data can be received in response to interactions with a participant using a participant device. Depending upon implementation-specific or other considerations, participant data can be received based on responses by a participant to input triggers. For example, participant data can be received based on responses by a participant to a quiz that includes questions as input triggers. In another example, participant data can be received based on responses by a participant to advertisements of products included as input triggers.

The flowchart 800 continues to module 804, where attributes of the participant are determined from the participant data. Attributes of a participant can be determined form participant data by a participant attribute determination engine. Attributes of a participant can include features, characteristics, and traits defining a participant. For example, attributes of a participant can include an age and sex of the participant. Depending upon implementation-specific or other considerations, attributes of a participant can include products a participant uses. Attributes of a participant can serve as market segmentation variables used to segment participants into groups. Examples of market segmentation variables can include geographic, demographic, psychographic, behavioristic, and/or other data about one or more market segments.

The flowchart 800 continues to module 806, where a feature vector is defined. A feature vector can be defined by a feature vector definition engine. A feature vector can be defined to include an applicable number of participant attributes. Depending upon implementation-specific or other considerations, a feature vector can be defined to include one or a plurality of domains. A domain can include an organizational group into which an attribute can be categorized. For example, if an attribute defines a participant's nose, then the domain for the attribute can be a body categorization of the participant. In another example, if an attribute defines a participant's shopping tendencies, then the domain for the attribute can be a mental classification of the participant. Further depending upon implementation-specific or other considerations, a feature vector can be defined to include one or a plurality of classes. A class can include an organizational group serving as a subset within a domain, into which an attribute can be categorized. For example, if a domain for an attribute is a body categorization, and the attribute described a feature of a participant's nose, then the class can be a nose categorization. A feature vector can be defined to include an attribute field in which an attribute value indicating an attribute of a participant can be included. An attribute field included in a feature vector can be categorized into a domain and/or a class. Depending upon implementation-specific or other considerations, an attribute field can exist in a plurality of feature vectors in either or both different domains and classes of the feature vectors.

The flowchart 800 continues to module 808, where a participant feature vector is generated for the participant based on the defined feature vector and the attributes of the participant. A participant feature vector can be generated for the participant by a participant feature vector determination engine. A participant feature vector can be determined for the participant based on a feature vector defined at module 806. Additionally, a participant feature vector for the participant can be determined based the attributes of the participant determined at module 804 from the participant data. A participant feature vector for the participant can be generated by populating attribute fields in the feature vector defined at module 806. For example, if the defined feature vector includes an attribute field for whether a participant is single, and the it is determined the participant is single, then the attribute field in a participant feature vector can be populated with a value indicating the participant is single.

The flowchart 800 continues to module 810, where the participant is mapped to at least one cluster using the participant feature vector. The participant can be mapped to at least one cluster using the participant feature vector by a cluster mapping engine. Depending upon implementation-specific or other considerations, the participant can be mapped to at least one defined cluster. Specifically, the participant can be mapped to a cluster based on attributes of the participant, as indicated by the participant feature vector for the participant. For example, if a participant feature vector of the participant indicates that the participant has blue eyes, then the participant can be mapped to a cluster defined by participants with blue eyes. Depending upon implementation-specific or other considerations, the participant can be mapped to a cluster based on a plurality of attributes of the participant.

The flowchart 800 continues to module 812, where the participant is mapped to a portrait based on the least one cluster. The participant can be mapped to a portrait based on the least at one cluster by a cluster based portrait mapping engine. A portrait can include a plurality of clusters and can be defined by the attributes of participants in the plurality of clusters. In one example, if a participant is in a cluster of participants with blue eyes and in another cluster of participants with brown hair, then the participant can be mapped to a portrait that includes the cluster of participants with brown hair and the cluster of participants with blue eyes. Attributes of participant defining clusters included in a portrait can define the portrait. Depending upon implementation-specific or other considerations, the participant can take on a specific attribute defining a portrait to which the participant is mapped, even if it unknown whether the participant has the specific attribute. For example, if the participant is mapped to a portrait that is defined by participant attributes including green eyes, and it is unknown what the eye color of the participant is, then it can be assumed that the participant has green eyes.

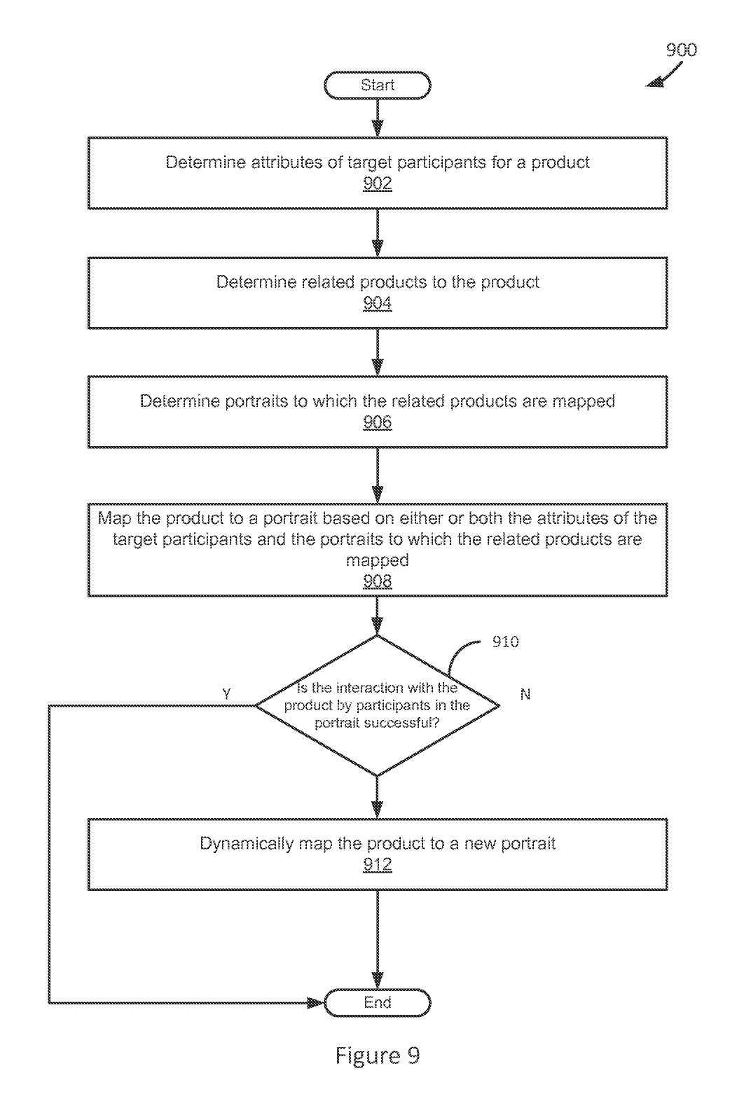

FIG. 9 depicts a flowchart 900 of an example of a method for mapping a product to a portrait. The flowchart 900 begins at module 902, where attributes of target participants for a product are determined. Attributes of a target participant for a product can be determined by a product to portrait mapping engine. Target participants of a product can include participants who are expected to like or purchase the product, and/or participants who do like or purchase the product. Depending upon implementation-specific or other considerations, attributes of a target participant can be determined based on input received from a developer or distributor of a product. Further depending upon implementation-specific or other considerations, attributes of a target participant can be determined based on a portrait and/or a cluster to which target participant are mapped. Depending upon implementation-specific or other considerations, attributes of a target participant can be determined based on participant feature vectors of the target participants.

The flowchart 900 continues to module 904, where related products to the product are determined. Products can be related if they share a same target audience, perform a related or the same function, and/or are developed by the same or related developers or manufacturers. A product to portrait mapping engine can determined related products to the product.

The flowchart 900 continues to module 906, where portraits to which the related products are mapped are determined. Portraits to which the related products are mapped can be determined by a product to portrait mapping engine. Depending upon implementation-specific or other considerations, portraits to which the related products are mapped can be determined from product portrait data stored in a product to portrait datastore.

The flowchart 900 continues to module 908, where the product is mapped to a portrait based on either or both the attributes of the target participant and the portraits to which the related products are mapped. The product can be mapped to a portrait by a product to portrait mapping engine. Depending upon implementation-specific or other considerations, the product can be mapped to a portrait to which related products are mapped. Further depending upon implementation-specific or other considerations, the product can be mapped to a portrait to which target participants are mapped.

The flowchart 900 continues to decision point 910, where it is determined whether the interaction with the product by participants in the portrait is successful. Success in participant interactions can include either or both, whether participants are purchasing a product and whether participants indicate they like or express as desire for the product. A participant attribute data acquisition system and/or a mapped product based participant interaction engine can determine whether interactions with the product by participants in the portrait are successful.

If it is determined that interactions with the product by participants in the portrait are not successful at decision point 910, then the flowchart 900 continues to module 912, where the product is dynamically mapped to a new portrait. The product can be mapped to a new portrait by a product to portrait mapping engine. Depending upon implementation-specific or other considerations, the product can be mapped to a new portrait to which related products are mapped. Further depending upon implementation-specific or other considerations, the product can be mapped to a new portrait to which target participants are mapped.

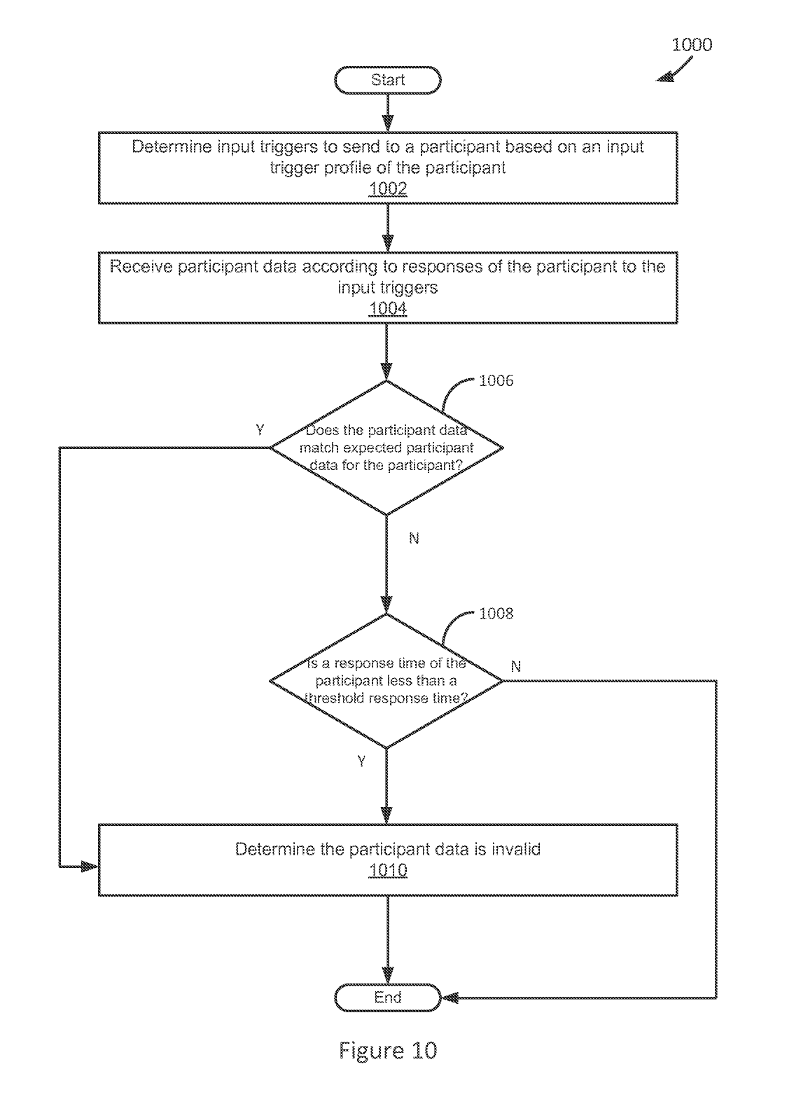

FIG. 10 depicts a flowchart 1000 of an example of a method for determining if participant data is valid. The flowchart 1000 begins at module 1002, where input triggers to send to a participant are determined based on an input trigger profile of the participant. Input triggers to send can be determined by an input trigger selection engine. Depending upon implementation-specific or other considerations, a participant input trigger profile can include input triggers that have been sent to a participant and/or whether participant data generated in response to the input triggers is valid. In a specific implementation, input triggers to send to a participant can be determined based on previous input triggers sent to the participant, as indicated by a participant input trigger profile. Further depending upon implementation-specific or other considerations, input triggers to send to a participant can be determined based on whether participant data received from the participant is valid. Depending upon implementation-specific or other considerations, input triggers to send to a participant can be determined based on clusters, portraits and products to which the participant have been mapped. Further depending upon implementation-specific or other considerations, input triggers to send to a participant can be determined based on a product of a product giveaway that the participant desires to enter.

The flowchart 1000 continues to module 1004 where participant data is received according to responses of the participant to the input triggers sent at module 1002. For example, participant data can be received based on responses by a participant to a quiz that includes questions as input triggers. In another example, participant data can be received based on responses by a participant to advertisements of products included as input triggers. Participant data can be collected by a participant attribute data acquisition system.

The flowchart 1000 continues to decision point 1006 where it is determined whether the participant data matches expected participant data for the participant. A participant data verification engine can determine whether the participant data matches expected participant data for the participant. Expected participant data for a participant can be determined according to an applicable statistical means, such as k-means clustering.

If it is determined that the participant data matches expected participant data for the participant, then the flowchart 1000 continues to decision point 1008, where it is determined if the response time of the participant is less than a threshold response time. A participant data verification engine can determine whether the participant data is generated for a response time of the participant that is less than a threshold response time. A threshold response time can include a minimum amount of time for a participant to perceive and give a truthful response to generate valid participant data. For example, if a participant responds to a quiz question quickly, such as to indicate that the participant did not actually perceive the quiz question, then it can be determined that participant data created in response to the participant answering the quiz question is not within a threshold response time.

If it is determined that the response time of the participant is less than a threshold response time, then the flowchart 1008 continues to module 1010 where it is determined that the participant data is valid. The participant data can be determined to be valid by a participant data verification engine.

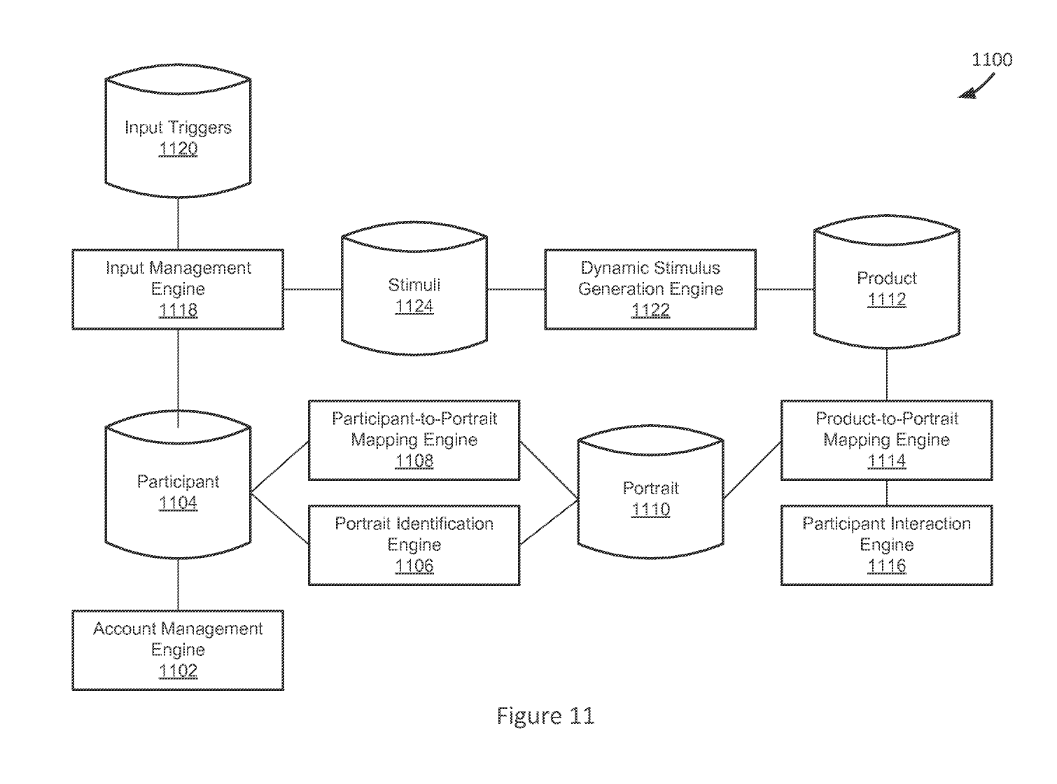

FIG. 11 depicts a diagram 1100 of an example of a system for participant interaction after product-to-portrait mapping. The diagram 1100 includes an account management engine 1102, a participant datastore 1104, a portrait identification engine 1106, a participant-to-portrait mapping engine 1108, a portraits datastore 1110, a products datastore 1112, a product-to-portrait mapping engine 1114, a participant interaction engine 1116, an input management engine 1118, an input triggers datastore 1120, a dynamic stimulus generation engine 1122, and a stimuli datastore 1124. In a specific implementation, one or more of the engines and datastores are coupled to one another via a computer-readable medium (not shown). FIG. 11 is intended to illustrate a specific implementation of several of the techniques discussed in this paper.

In the example of FIG. 11, the account management engine 1102 is intended to represent a subsystem capable of managing accounts associated with participants in programs offered by the system illustrated in the diagram 1100. The account management engine 1102 can be tasked with managing account details, such as user name, password, and other applicable data that is not specifically mentioned below. In a specific implementation, the account management engine 1102 obtains information sufficient to facilitate interaction with a participant, whether via private messages, such as email, SMS, or the like, public messages, such as posting on a message board, to a group, or the like, telephone calls, physical mail, or some other public, private, or personal communication channel. The account management engine 1102 may or may not also be capable of ascertaining which of multiple communication channels is preferred, prohibited for certain purposes, old, or the like, either through automated means or by receiving relevant input from a participant or the participant's agent.

In the example of FIG. 11, the participant datastore 1104 is coupled to the account management engine 1102. The participant datastore 1104 is intended to represent a datastore capable of storing identifiable attributes associated with a participant. A new participant could conceivably have no meaningful attributes (resulting in a mapping to a default profile), or the system could be designed to require at least some geographic, demographic, psychographic, or behavioristic data.

In the example of FIG. 11, the participant-to-portrait identification engine 1106 is coupled to the participant datastore 1104. In a specific implementation, the participant-to-portrait identification engine 1106 uses a statistical analysis of multiple participants to break the participants into statistically meaningful groups. A single participant can be a member of many groups. A single attribute of a participant can also be part of multiple groups. The groups need not have a human-understandable or easily explained correlation; in a specific implementation, the groups are generated from statistical analysis that may result in associations that are neither predicted nor known to administrators of the system. The groups can also be formed or dissipate over time as ongoing statistical analysis causes the groups to evolve.

In the example of FIG. 11, the participant-to-portrait mapping engine 1108 is coupled to the participant datastore 1104. For each participant, the participant-to-portrait mapping engine 1108 can map the participant to a set of portraits, which the participant-to-portrait identification engine 1106 has identified.

In the example of FIG. 11, the portrait datastore 1110 is coupled to the participant-to-portrait identification engine 1106 and the participant-to-portrait mapping engine 1108. The portrait datastore 1110 is intended to represent a logical component; the portrait datastore 1110 could be part of the same physical datastore as one or more of the other datastore components of FIG. 11. The state maintained by the portrait datastore 1110 includes identified portraits, a set of attributes associated with each portrait, and a set of participants associated with each portrait.

In the example of FIG. 11, the product datastore 1112 is intended to represent attributes of products or services that might be made exposed to participants, either physically by providing the products or services, or virtually by providing an explanation of, coupon for, or other reference to the products or services.

In the example of FIG. 11, the product-to-portrait mapping engine 1114 is coupled to the portrait datastore 1110 and the product datastore 1112. The product-to-portrait mapping engine 1114 maps products to identified portraits, resulting in a transitive association between participants that are associated with a particular portrait and products that are also associated with the particular portrait.

In the example of FIG. 11, the participant interaction engine 1116 is coupled to the product-to-portrait mapping engine 1114. The participant interaction engine 1116 interfaces with a communications subsystem using a channel or address identifiable from the participant datastore 1104. For example, if a product is transitively associated with a participant, the participant interaction engine 1116 could identify a mailing address and send the product to the participant. Similarly, the participant interaction engine 1116 could send a coupon via an email address associated with a participant. The participant interaction engine 1116 may have specific rules about products, such as a number that can be sent before a promotion ends, a time limit, a limit of one per address, or the like.

In the example of FIG. 11, the input management engine 1118 is coupled to the participant datastore 1104. The input management engine 1118 is intended to represent an engine capable of providing data associated with a participant for storage in the participant datastore 1104 in association with the participant.

In the example of FIG. 11, the input triggers datastore 1120 is coupled to the input management engine 1118. The input triggers datastore 1120 is intended to represent mechanisms through which the input management engine can receive data. For example, an input trigger could include a participant taking a quiz and submitting the answers of the quiz to the input management engine 1118.

In the example of FIG. 11, the dynamic stimulus generation engine 1122 is coupled to the product datastore 1112. The dynamic stimulus generation engine 1122 can generate stimuli appropriate for a given participant on the fly. For example, if a participant has answered questions about a particular product type, the dynamic stimulus generation engine 1122 can generate more specific questions. In this way, a participant's profile can be built up over time in a non-redundant and targeted manner. The dynamic stimulus generation engine 1122 can also take into account environmental variables, such as the location from which the input management engine 1118 is capturing data. For example, if a participant can be identified as having an interest in movies by virtue of the participant being identifiable as being on a movie-reviewing website, the dynamic stimulus generation engine 1122 might favor stimuli associated with movies.

In the example of FIG. 11, the stimuli datastore 1124 stores the dynamic stimuli generated by the dynamic stimulus generation engine 1122 for use by the input management engine 1118 to capture participant data for storage in the participant datastore 1104.

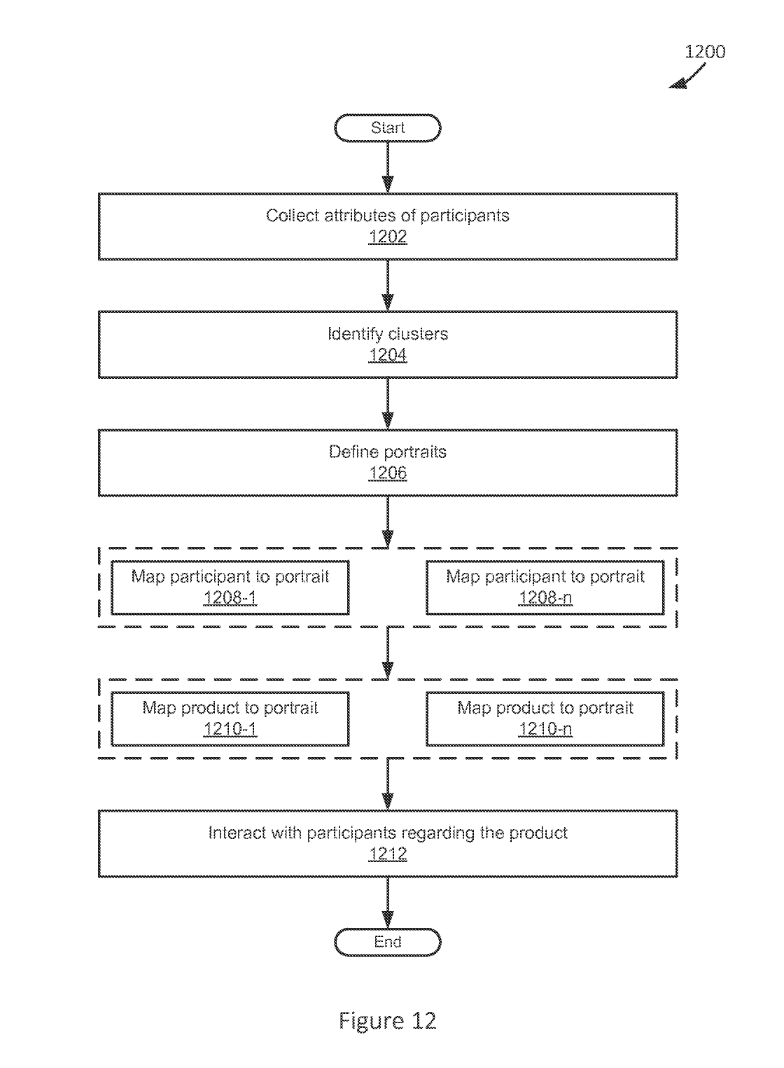

FIG. 12 depicts a flowchart 1200 of an example of a method for participant interaction after product-to-portrait mapping. In the example of FIG. 12, the flowchart 1200 starts at module 1202 with collecting attributes of participants. The attributes can be collected using an applicable technique, such as was described previously in this paper.

In the example of FIG. 12, the flowchart 1200 continues to module 1204 with identifying clusters. Clusters are determined statistically using an applicable technique, such as was described previously in this paper.

In the example of FIG. 12, the flowchart 1200 continues to module 1206 with defining portraits. Clusters are used to define portraits such that each participant can be associated with a number of different portraits.

In the example of FIG. 12, the flowchart 1200 continues to modules 1208-1 to 1208-n with mapping participants to portraits. Each participant can be mapped to a number of different portraits. Participants that cannot be mapped to a portrait based upon clusters of attributes may or may not be mapped to a default portrait.

In the example of FIG. 12, the flowchart 1200 continues to modules 1210-1 to 1210-n with mapping products or services to portraits. Each product or service can be mapped to a number of different portraits. It may be noted the nth participant (1208-n) and the nth product (1210-n) is not intended to suggest ‘n’ is the same for participants and products.

In the example of FIG. 12, the flowchart 1200 ends at module 1212 with interacting with participants regarding the product or service. The interaction with participants will generally be accomplished by feeding relevant information (such as contact information and the product or something associated with the product or service) to a relevant communication subsystem that provides the product or something associated with the product or service to the participant.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
defining a plurality of business domains;
collecting attributes for a plurality of participants;
identifying clusters comprising subsets of the plurality of participants;
assigning a portrait including features of a set of clusters into a business domain of the plurality of business domains;
mapping a participant of the plurality of participants to the portrait;
interacting with the participant in association with a product or service associated with the portrait.

2. The method of claim 1, further comprising acquiring participant data for the participant, wherein the collecting attributes for a plurality of participants includes determining attributes of the participant from the participant data.

3. The method of claim 2, further comprising:
determining validity of the participant data;
preventing determining the attributes of the participant from the participant data if it is determined the participant data is invalid.

4. The method of claim 2, further comprising:
determining a response time of the participant in interacting to generate the participant data;
comparing the response time of the participant to a threshold response time to determine the validity of the participant data.

5. The method of claim 2, further comprising:
determining expected participant data according to an expected response of the participant in interacting to generate the participant data;
comparing the expected participant data to the participant data to determine the validity of the participant data.

6. The method of claim 1, further comprising:
defining a feature vector, wherein the feature vector includes an organizational data structure with domain, class, and attribute fields that can be populated with values associated with attributes of the participant;
generating a participant feature vector for the participant using the feature vector and the attributes for the plurality of participants;
wherein the mapping a participant of the plurality of participants to the portrait includes mapping the participant to the portrait using the participant feature vector;
mapping the product or service to the portrait using portraits to which related products or services are mapped;
mapping the product or service to the participant based on the mapping of the participant to the portrait and the mapping of the product or service to the portrait.

7. The method of claim 6, wherein the feature vector is an organizational data structure including a domain, a class, and attribute fields that can be populated with values indicating the attributes of the participant.

8. The method of claim 1, further comprising:
defining a feature vector, wherein the feature vector includes an organizational data structure with domain, class, and attribute fields that can be populated with values associated with attributes of the participant;
generating a participant feature vector for the participant using the feature vector and the attributes for the plurality of participants;
wherein the mapping a participant of the plurality of participants to the portrait includes mapping the participant to the portrait using the participant feature vector;
mapping the product or service to the portrait based on whether successful interactions occur with the product or service by another participant of one of the subsets of the plurality of participants;
mapping the product or service to the participant based on the mapping of the participant to the portrait and the mapping of the product or service to the portrait.

9. The method of claim 6, wherein the feature vector is an organizational data structure including a domain, a class, and attribute fields that can be populated with values indicating the attributes of the participant.

10. The method of claim 1, wherein the set of clusters is defined based on a grouping of participant attributes, including an attribute of the participant, shared by a subset of the subsets of the plurality of participants.

11. A system comprising:
a participant attribute determination engine that:
defines a plurality of business domains;
collects attributes for a plurality of participants;
a cluster based portrait mapping engine that:
identifies clusters comprising subsets of the plurality of participants;
assigns a portrait including features of a set of clusters into a business domain of the plurality of business domains;
maps a participant of the plurality of participants to the portrait;
a participant interaction engine that interacts with the participant in association with a product or service associated with the portrait.

12. The system of claim 11, further comprising a participant attribute data acquisition system that acquires participant data for the participant, wherein the collecting attributes for a plurality of participants includes determining attributes of the participant from the participant data.

13. The system of claim 12, wherein the participant attribute data acquisition system:
determines validity of the participant data;
prevents determining the attributes of the participant from the participant data if it is determined the participant data is invalid.

14. The system of claim 12, the participant attribute data acquisition system:
determines a response time of the participant in interacting to generate the participant data;
compares the response time of the participant to a threshold response time to determine the validity of the participant data.

15. The system of claim 12, the participant attribute data acquisition system:
determines expected participant data according to an expected response of the participant in interacting to generate the participant data;
compares the expected participant data to the participant data to determine the validity of the participant data.

16. The system of claim 11, further comprising:
a feature vector definition engine that defines a feature vector, wherein the feature vector includes an organizational data structure with domain, class, and attribute fields that can be populated with values associated with attributes of the participant;
a participant feature vector determination engine that generates a participant feature vector for the participant using the feature vector and the attributes for the plurality of participants, wherein the mapping a participant of the plurality of participants to the portrait includes mapping the participant to the portrait using the participant feature vector;
a product or service to portrait mapping engine that maps the product or service to the portrait using portraits to which related products or services are mapped;
a portrait based product to participant mapping engine that maps the product or service to the participant based on the mapping of the participant to the portrait and the mapping of the product or service to the portrait.

17. The system of claim 16, wherein the feature vector is an organizational data structure including a domain, a class, and attribute fields that can be populated with values indicating the attributes of the participant.

18. The system of claim 11, further comprising:
a feature vector definition engine that defines a feature vector, wherein the feature vector includes an organizational data structure with domain, class, and attribute fields that can be populated with values associated with attributes of the participant;
a participant feature vector determination engine that generates a participant feature vector for the participant using the feature vector and the attributes for the plurality of participants, wherein the mapping a participant of the plurality of participants to the portrait includes mapping the participant to the portrait using the participant feature vector;
a product or service to portrait mapping engine that maps the product or service to the portrait based on whether successful interactions occur with the product or service by another participant of one of the subsets of the plurality of participants;
a portrait based product to participant mapping engine that maps the product or service to the participant based on the mapping of the participant to the portrait and the mapping of the product or service to the portrait.

19. The system of claim 18, wherein the feature vector is an organizational data structure including a domain, a class, and attribute fields that can be populated with values indicating the attributes of the participant.

20. The system of claim 11, wherein the set of clusters is defined based on a grouping of participant attributes, including an attribute of the participant, shared by a subset of the subsets of the plurality of participants.

21. A system comprising:
means for defining a plurality of business domains;
means for collecting attributes for a plurality of participants;
means for identifying clusters comprising subsets of the plurality of participants;
means for assigning a portrait including features of a set of clusters into a business domain of the plurality of business domains;
means for mapping a participant of the plurality of participants to the portrait;
means for interacting with the participant in association with a product or service associated with the portrait.
